(19) United States
(12) Patent Application Publication
(10) Pub. No.: US 2009/0235010 A1
(43) Pub. Date: Sep. 17, 2009

(54) DATA PROCESSING CIRCUIT, CACHE SYSTEM, AND DATA TRANSFER APPARATUS

(75) Inventor: Tomoya SUZUKI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 12/400,333

(22) Filed: Mar. 9, 2009

(30) Foreign Application Priority Data
Mar. 12, 2008 (JP) 2008-062884

(51) Int. Cl. G06F 12/00; G06F 13/28

(52) U.S. Cl. 711/3; 710/35; 711/E12.053

(57) ABSTRACT

To include an address generating unit that generates a series of access destination addresses at a time of performing a burst access to the external memory, starting from an initial address to be accessed, so that number of inverted bits along with the address change becomes smallest, and a data processing unit that reads data held in a data holding unit and writes the data in an external memory in order of the access destination addresses, or reads data from the external memory in order of the access destination addresses and writes the data in the data holding unit.

### CROSS-REFERENCE TO RELATED APPLICATIONS

This application is based upon and claims the benefit of priority from the prior Japanese Patent Application No. 2008-062884, filed on Mar. 12, 2008; the entire contents of which are incorporated herein by reference.

### BACKGROUND OF THE INVENTION

1. Field of the Invention

The present invention relates to a data processing circuit, a cache system, and a data transfer apparatus that perform burst transfer of data with an external memory.

2. Description of the Related Art

Recently, in the field of semiconductor devices including memories, the ratio of power consumed at a wiring portion such as a signal line with respect to the entire power consumption is increasing along with the downsizing of devices. Accordingly, techniques for reducing the power consumed at the wiring portion have been under review. For example, Japanese Patent Application Laid-Open No. 2006-251837 describes a technique of reducing power consumption at the time of driving an I/O pin used for connection with an external memory.

However, the converter described in Japanese Patent Application Laid-Open No. 2006-251837 simply converts address data to reduce the number of varying bits. Therefore, if the converter is applied only to a device as a part of a system in which there are multiple devices that access a common external memory to perform address conversion, there is a problem that the correspondence between the address and data does not match between respective devices.

Accordingly, there is a limitation in the converter described in Japanese Patent Application Laid-Open No. 2006-251837 that the converter needs to be applied to all devices that access the common external memory, and therefore it is not possible to reduce the power consumption by applying the converter only to a part of the multiple devices accessing the common external memory.

### BRIEF SUMMARY OF THE INVENTION

A data processing circuit that performs a burst access to an external memory according to an embodiment of the present invention comprises an address generating unit that generates a series of access destination addresses at a time of performing a burst access to the external memory, starting from an initial address to be accessed, so that number of inverted bits along with the address change becomes smallest; a data holding unit that holds data to be written in the external memory or data read from the external memory; and a data processing unit that reads the data held in the data holding unit and writes the data in the external memory in order of the access destination addresses, or reads the data from the external memory in order of the access destination addresses and writes the data in the data holding unit.

A cache system according to an embodiment of the present invention comprises the data processing circuit according to claim 1 and a cache memory, wherein data reading and data writing with respect to the cache memory are performed by using a burst access by the data processing circuit.

A data transfer apparatus according to an embodiment of the present invention comprises the data processing circuit according to claim 1; and a data buffer that temporarily stores the data acquired from outside, wherein DMA transfer between two external memories is performed by using a burst access by the data processing circuit.

### BRIEF DESCRIPTION OF THE DRAWINGS

FIG. 1 is a block diagram of a configuration example of a cache system including a data processing circuit according to a first embodiment of the present invention;

FIG. 2 is an operation example of the cache system when a memory access request is received;

FIG. 3 is an operation example of the cache system when a cache hit or a cache miss is checked;

FIG. 4 is an operation example of the cache system when a write-back operation is performed;

FIG. 5 is a timing chart of the write-back operation;

FIG. 6 is a table of comparison results between the total number of switching when a burst access is performed by applying a conventional method and the total number of switching when a burst access is performed by applying a method according to the first embodiment;

FIG. 7 is a block diagram of another configuration example of the cache system including the data processing circuit according to the first embodiment;

FIG. 8 is a configuration example of a data transfer apparatus including a data processing circuit according to a second embodiment of the present invention;

FIG. 9 is one example of data to be DMA-transferred; and

FIG. 10 is a timing chart of a DMA transfer operation performed by the data transfer apparatus according to the second embodiment.

### DETAILED DESCRIPTION OF THE INVENTION

Exemplary embodiments of a data processing circuit, a cache system, and a data transfer apparatus according to the present invention will be explained below in detail with reference to the accompanying drawings. The present invention is not limited to the following embodiments.

In a first embodiment of the present invention, an example where a data processing circuit is applied to a write-back cache system is explained. As one example, a case of a cache system being incorporated in a central processing unit (CPU) is explained.

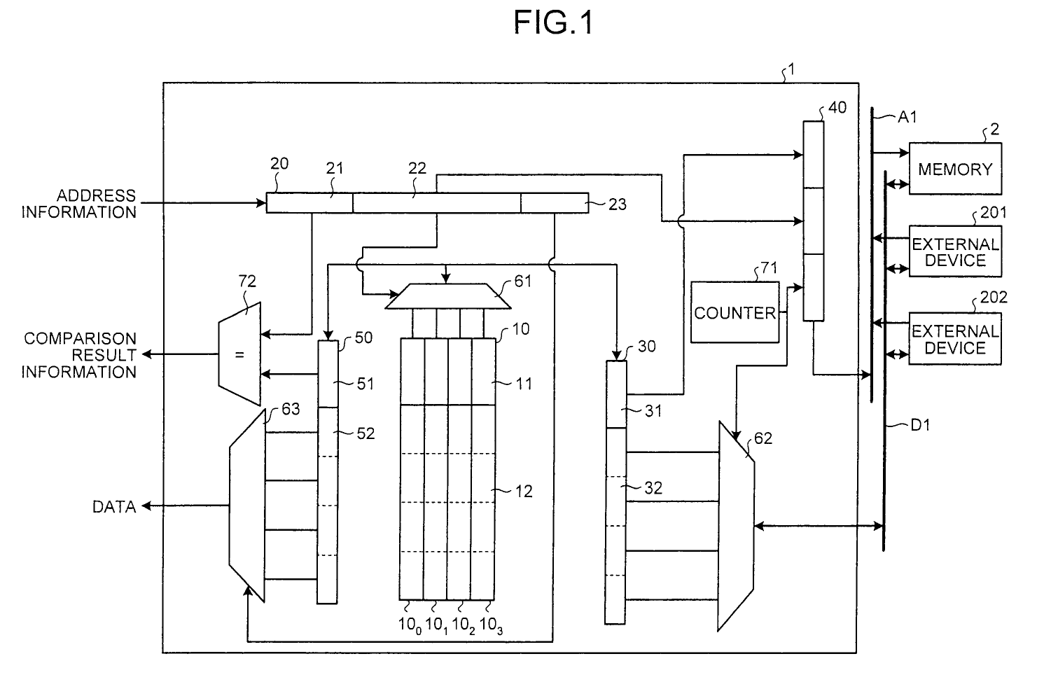

FIG. 1 is a block diagram of a configuration example of the cache system including the data processing circuit according to the first embodiment. A cache system 1 is incorporated in the CPU that reads and writes data between an external memory 2 and the CPU. The cache system 1 sequentially outputs addresses of access destinations to an address bus Al according to an instruction from a CPU core (not shown) and performs burst accesses to the memory 2 via a data bus D1. In the first embodiment, external devices 201 and 202 are other devices that access the memory 2, and are explained as a general cache system. For the following explanations, it is assumed that the width of the address bus and the width of the data bus are eight bits, respectively.

A configuration of the cache system 1 is explained next. The cache system 1 includes a cache memory 10, a first register 20, a second register 30, a third register 40, a fourth register 50, a first multiplexer/demultiplexer (MUX/DEMUX) 61, a second MUX/DEMUX 62, a multiplexer (MUX) 63, a counter 71, and a comparator 72. The third register 40 and the counter 71 constitute an address generator. The second MUX/DEMUX 62 constitutes a data processor.

The cache memory 10 holds data read from the memory 2 together with a tag, which is a higher-order bit of a storage destination address. The cache memory 10 includes a plurality of line fields 10₀ to 10₃, and the respective line fields include a tag field 11 for storing the tag and a data field 12 for storing data. In the configuration shown in FIG. 1, the number of lines (number of entries) storable in the cache memory 10 is 4.

The first register 20 stores an address indicating an area in the memory 2 received from the CPU core. The first register 20 includes a tag field 21 for storing a higher-order bit (tag) of the address acquired from the CPU core, an index field 22 for storing the fifth and sixth bits from the top of the address, and a word address field 23 for storing the seventh and eighth bits.

The second register 30 stores data to be written in the memory 2 or data read from the memory 2 and the tag thereof. The second register 30 includes a tag field 31 for storing a tag and a data field 32 for storing data.

The third register 40 is connected to the address bus A1, and stores address data to be output to the address bus A1. The third register 40 acquires and holds a tag stored in the tag field 31 in the second register 30 and an index stored in the index field 22 in the first register 20, and acquires and holds an output value when information is output from the counter 71. The third register 40 outputs the data held therein to the address bus A1 as address data of the access destination at the time of performing a burst access to the memory 2.

The fourth register 50 stores data to be output to the CPU core and the tag thereof. The fourth register 50 includes a tag field 51 for storing the tag and a data field 52 for storing data.

The first MUX/DEMUX 61 selects any one of a plurality of pieces of data stored in the cache memory 10 together with the tag thereof. The first MUX/DEMUX 61 also selects a line field for storing the data read by the memory 2 and stored in the second register 30 and the tag thereof, from the line fields constituting the cache memory 10.

When data is written in the memory 2, the second MUX/DEMUX 62 reads data from an area in the data field 32 of the second register 30, specified based on a value (gray code described later) output from the counter 71, and outputs the data to the data bus D1. When the data is read from the memory 2, the second MUX/DEMUX 62 acquires data from the data bus D1 and stores the acquired data in an area in the data field 32 of the second register 30, specified based on the value output from the counter 71.

The MUX 63 selects the data to be output to the CPU core from the data stored in the fourth register 50.

The counter 71 generates the gray code when the cache system 1 performs the burst access to the memory 2 and outputs the gray code to the third register 40 and the second MUX/DEMUX 62.

The comparator 72 compares the information stored in the tag field 21 in the first register 20 with the information stored in the tag field 51 of the fourth register 50, and outputs the comparison result to the CPU core.

An operation when the cache system 1 performs the burst access to the external memory 2 is briefly explained first. An operation when the cache system 1 burst-writes the data held therein to the memory 2 is explained here. To simplify the explanations, it is assumed that the data to be written in the memory 2 has be already written in the second register 30, and the address of an area to be accessed first by the burst access to the memory 2 has been already written in the first register 20.

When the burst access is started, the counter 71 starts counting, and outputs an initial value at a point in time when counting is started. The third register 40 having received the initial value outputs the address data corresponding to the initial value to the address bus A1. The second MUX/DEMUX 62 selects the data to be output to the data bus D1 from the data stored in the data field 32 based on the initial value output from the counter 71. As a result, the data corresponding to the output value (initial value) of the counter 71 in the data stored in the data field 32 is output to the data bus D1. Subsequently, the counter 71 periodically counts up to update the output value to the third register 40 and the second MUX/DEMUX 62. The address data output from the third register 40 to the address bus A1 is updated accordingly when the output value from the counter 71 is updated. When the output value from the counter 71 is updated, the second MUX/DEMUX 62 acquires the data corresponding to the updated value from the data field 32 and outputs the data to the data bus D1.

An operation when the cache system 1 outputs the data stored in the cache memory 10 to the CPU core via the MUX 63 is briefly explained next.

Upon reception of a memory access request requesting acquisition of the data held by the memory 2 from the CPU core, address information indicating the storage destination of the data is stored in the first register 20. The first MUX/DEMUX 61 selects one of the line fields 10₀ to 10₃ in the cache memory 10 based on the information stored in the index field 22 in the first register 20, and outputs the selected line field to the fourth register 50. The data in the tag field of the selected line field and the data in the data field 12 are respectively copied to the tag field 51 and the data field 52 of the fourth register 50. The MUX 63 acquires the data corresponding to the information stored in the word address field 23 in the first register 20 from the data field 52 and outputs the data to the CPU core. The comparator 72 compares the information stored in the tag field 21 with the information stored in the tag field 51, and outputs comparison result information indicating the result. When the information stored in the tag field 21 matches the information stored in the tag field 51, it is referred to as a cache hit, and when these do not match each other, it is referred to as a cache miss. When the comparison result received from the comparator 72 indicates that the information in the tag field 21 matches the information in the tag field 51, the CPU core determines that the data output from the MUX 63 is the desired data (data corresponding to the data acquisition request), and fetches the data.

Subsequently, an operation when the cache system 1 performs the burst access to the memory 2 by the data processing circuit according to the first embodiment is explained with reference to the drawings. Explained below is a burst-access operation performed when an access request to the memory 2 is received from the CPU core and the data corresponding to the access request (data desired for the CPU core) is not held in the cache memory 10. In this example, it is assumed that the data held in the cache memory 10 is in a dirty state (that is, a rewritten state).

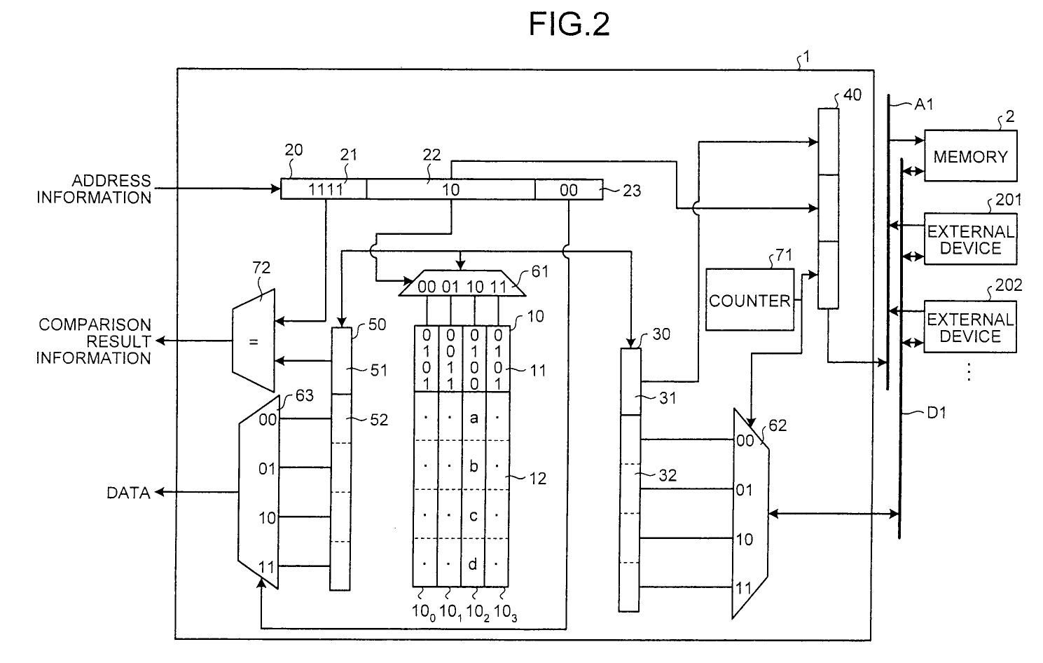

Upon reception of the memory access request from the CPU core to the memory 2, the cache system 1 stores the access destination address received from the CPU core in the first register 20. FIG. 2 depicts a state of the cache system 1 at a point in time when the access destination address included in the memory access request is stored in the first register 20. FIG. 2 is a specific example as to when a memory access request to an address 11111000 is received. It is assumed that 8-bit data ‘a’, ‘b’, ‘c’, and ‘d’ are respectively stored in line field 102 in the cache memory 10. It is also assumed that data has been already stored in other line fields.

When the access destination address is stored in the first register 20, the cache system 1 confirms whether the data corresponding to the stored access destination address is held in the cache memory 10, that is, the cache system 1 checks a cache hit or a cache miss.

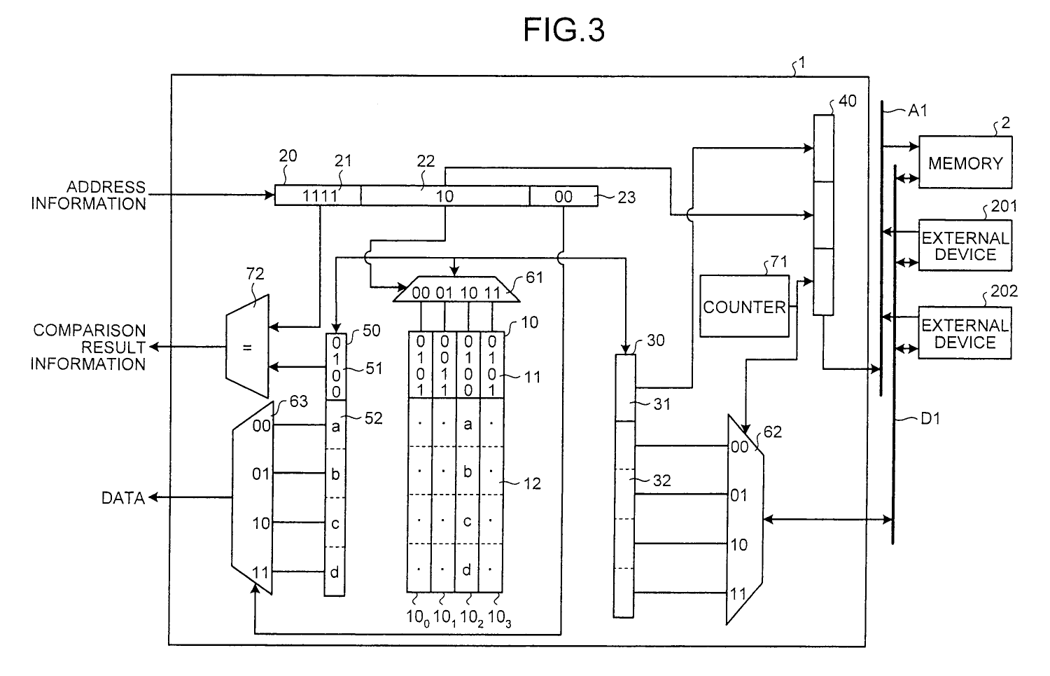

Specifically, the first MUX/DEMUX 61 fetches the index stored in the index field 22 of the first register 20, and selects the line field in the cache memory 10 corresponding to the fetched index to read the tag stored in the tag field 11 in the selected line field and the data stored in the data field 12. As a result, the tag stored in the selected line field is copied to the tag field 51, and the data is copied to the data field 52. FIG. 3 depicts a state immediately after this process has been performed, and indicates a state where “0100” is stored in the tag field 51, and ‘a’, ‘b’, ‘c’, and ‘d’ are sequentially stored in the data field 52.

The comparator 72 then reads and compares the information stored in the tag field 21 in the first register 20 with the information stored in the tag field 51 in the fourth register 50. When these pieces of information match each other, it means that the data requested by the CPU core is held (cache hit), and when they do not match each other, it means that the data is not held (cache miss). In this example (see FIG. 3), because “1111” is stored in the tag field 21 and “0100” is stored in the tag field 51, the comparator 72 determines a cache miss. The MUX 63 acquires the data corresponding to the information stored in the word address field 23 in the first register 20 from the data field 52 and outputs the data to the CPU core, regardless of the check result of whether it is a cache hit or a cache miss.

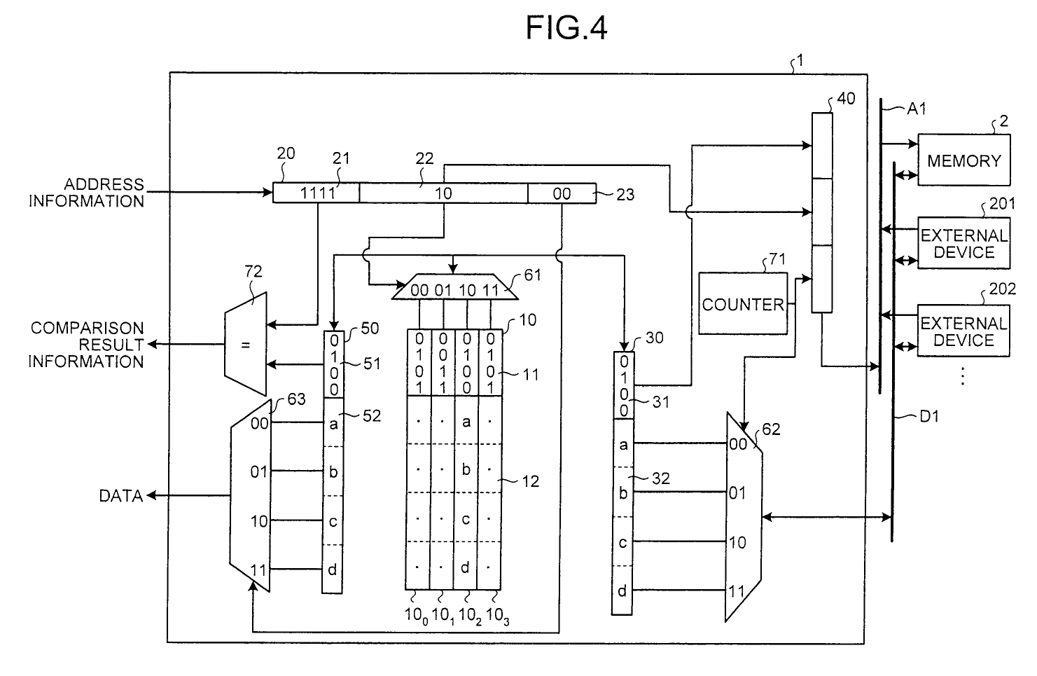

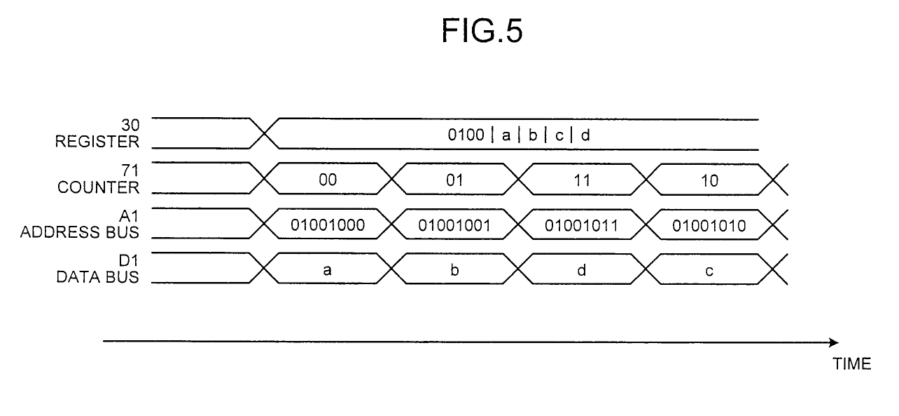

When a cache miss occurs, the cache system 1 needs to acquire the data requested by the CPU core from the memory 2. On the other hand, to acquire the data from the memory 2, the cache system 1 needs to secure an area for storing the acquired information. Accordingly, the cache system 1 performs the burst access to the memory 2, and writes back the data stored in the selected line field into the memory 2, thereby securing the area for storing the data newly read from the memory 2. A write-back operation is explained with reference to FIGS. 4 and 5.

In the cache system 1, as shown in FIG. 4, the first MUX/DEMUX 61 reads the data in the cache line to be written back into the memory 2 (a cache line determined as a cache miss in the above process) and the tag thereof from the cache memory 10 (the line field 10₂) and stores these in the second register 30. As a result, “0100” is stored in tag field 31 in the second register 30, and ‘a’, ‘b’, ‘c’, and ‘d’ are sequentially stored in the data field 32. The pieces of data (a, b, c, and d) stored in the data field 32 of the second register 30 are burst-output to the data bus D1 for every eight bits, which is the width of the data bus (that is, for each a, b, c, and d).

A burst-output operation of the data stored in the data field 32 performed by the data processing circuit according to the first embodiment is explained with reference to FIG. 5.

At a point in time when the cache system 1 starts the burst transfer, an initial value “00” is output from the counter 71. Accordingly, information stored in the third register 40 becomes “01001000”, which is output to the address bus A1 as the access destination address. At this time, the output value (initial value “00”) of the counter 71 is also output to the second MUX/DEMUX 62, and the second MUX/DEMUX 62 selects data corresponding to the received value and outputs the data to the data bus D1. In an example shown in FIG. 4, the second MUX/DEMUX 62 selects and outputs data “a”.

When a predetermined time has passed thereafter and the counter 71 counts up, the output value from the counter 71 changes to “01”. Accompanying this procedure, the information stored in the third register 40 becomes “01001001”, which is output to the address bus A1, and data ‘b’ is output from the second MUX/DEMUX 62.

Thereafter, when the counter 71 counts up again, the output value thereof changes to “11”, because the counter 71 is a counter that generates the gray code. Accompanying this procedure, “01001011” is output from the third register 40 to the address bus A1. At this time, the second MUX/DEMUX 62 selects data ‘d’ associated with the output value “11” from the counter. As a result, ‘d’ is output to the data bus D1, and the correspondence between the address output to the address bus A1 and the data output to the data bus D1 is maintained.

When the counter 71 further counts up, the counter 71 outputs “10”. Accompanying this procedure, “01001010” is output from the third register 40 to the address bus A1. The second MUX/DEMUX 62 outputs ‘c’ corresponding to the address “01001010” to the data bus D1.

2-bit information (gray code) output from the counter 71 is explained. The counter 71 changes only one bit of the 2-bit output every time the counter counts up, and does not change two bits simultaneously. For example, when the initial value (initial output)is “00”, the output value is changed in order of “00”→“01”→“11”→“10”→“00”→“01”, or in order of “00”→“10”→“11”→“01”→“00”→“10”, Therefore, the number of times for changing the bit decreases as compared to a general 2-bit counter (that increments and changes the output value like “00”→“01”→“10”→“11”→“00”. Accordingly, the cache system 1 can reduce the power consumption in the address bus A1 than in the case that the general 2-bit counter is used instead of the counter 71. Further, because data corresponding to the output value of the counter 71 is selected and output, the correspondence between the address and the data does not change before and after the burst transfer process (the correspondence is maintained).

According to the above operation, the cache system 1 writes back the data stored in the line field in the cache system 1. When the write-back operation shown in the above operation example is performed, ‘a’ is written in the area “01001000” of the memory 2, ‘b’ is written in the area “01001001”, ‘c’ is written in the area “01001010”, and ‘d’ is written in the area “01001011”.

Meanwhile, in the cache system provided in the external devices 201 and 202, when the burst access to the memory 2 is to be performed, the access destination address is generated while incrementing the top address of the area to be burst-accessed. Therefore, when data writing by the burst access is to be performed with respect to the addresses 01001000 to 01001011 as in the operation example of the cache system 1 described above, the external devices 201 and 202 changes the output value to the address bus Al in order of “01001000”→“01001001”→“01001010”→“01001011”, and at this time, sequentially outputs ‘a’, ‘b’, ‘c’, and ‘d’ to the data bus D1. That is, in the data writing by the burst access to 01001000 to 01001011, ‘a’ is first written in the area of 01001000, ‘b’ is then written in the area of 01001001, ‘c’ is written in the area of 01001010, and lastly, ‘d’ is written in the area of 01001011.

Therefore, in the burst access process performed by the cache system 1 according to the first embodiment, the order of address data to be output to the address bus A1 and the order of data to be output to the data bus D1 are different from those in the burst access process performed by the external devices 201 and 202. However, all pieces of data stored in the second register 30 are finally stored correctly in places to be stored in the memory 2. That is, the correspondence between the pieces of data and addresses is maintained before and after the burst access process.

The burst-access operation when the data is read from the memory 2 and stored in the cache memory 10 is the same as that when the data is burst-transferred to the memory 2. An operation when the burst access is performed and data is read from the memory 2 is briefly explained below.

In the burst access at the time of reading the data from the memory 2, the counter 71 starts counting synchronously with start of the burst access, and the information output from the counter 71 is transferred to the third register 40 and the second MUX/DEMUX 62, as in the case that the data is burst-transferred to the memory 2. The third register 40 outputs the address data corresponding to the information received from the counter 71 to the address bus A1. On the other hand, the second MUX/DEMUX 62 acquires the data output from the memory 2 to the data bus D1, and stores the acquired data in the area in the data field 32 of the second register 30, which is specified based on the information received from the counter 71. When the burst access to the memory 2 finishes, the data read from the memory 2 and stored in the second register 30 is stored in the cache memory 10 via the first MUX/DEMUX 61.

For reference, in a write-back operation by the cache system that uses the general 2-bit counter to perform a sequential access, the output to the address bus A1 changes like “01001000”→“01001001” (1-bit change)→“01001010” (2-bit change)→“01001011” (1-bit change), which is a 4-bit change in total (four switching operations occur). However, in the write-back operation by the cache system 1 according to the first embodiment, the output to the address bus A1 changes like “01001001”→“01001011” (1-bit change)→“01001010” (1-bit change)→“01001000” (1-bit change), which is a change of three bits in total.

When the counter outputs a value other than “00” as the initial value (in the case of a counter having a critical-word-first function), the number of switching further decreases. For example, when 4-byte transfer in the above example is started from “01001001”, in the general cache system, the output changes in order of “01001001”→“01001010” (2-bit change)→“01001011” (1-bit change)→“01001000” (2-bit change), in which the total number of switching becomes 5. In the cache system 1 according to the first embodiment, however, the total number of switching becomes 3.

In the first embodiment, to simplify the explanations, an example in which the number of bits of the address, which changes at the time of the burst access, is two has been explained. However, also in a case that the address changes in three or more bits, the cache system 1 can control the address data output so that the number of switching is reduced by a gray code counter, for example.

Thus, in the first embodiment, when the data is transferred to the memory 2 by the burst access, the access destination address to be output to the memory via the address bus is changed bit by bit using the gray code generated by the counter 71. At this time, the second MUX/DEMUX 62 that selects the data to be output to the memory 2 from the second register 30 selects the data corresponding to the access destination address output to the memory 2, based on the gray code generated by the counter 71. Accordingly, the number of address bits (the number of switching) that change at the time of the burst access can be reduced than in a conventional case, and the correspondence between the respective pieces of data handled by the burst access and the addresses corresponding thereto can be maintained before and after the burst access process. Therefore, even when the data processing circuit according to the first embodiment is applied to a partial device in the system in which a plurality of devices accesses a common external memory, the power consumption in the address bus between the respective devices and the common external memory can be individually reduced, while maintaining the state where the correspondence between the address and the data matches between these devices.

Further, flexible use can be considered such that the data processing circuit according to the first embodiment is applied only to a device having high frequency of performing the burst access, among these devices that access the common external memory. When the data processing circuit according to the first embodiment is applied, switching noise can be also reduced as well as the power consumption.

This effect becomes more distinct when the present invention is compared with a conventional example. In the known example, a converter that converts the address using the gray code is provided between the respective devices accessing the external memory and the external memory, and the converter converts the continuous address data output from these devices using the gray code, thereby reducing the power consumption in the address bus at the time of transferring the data from these devices to the external memory. In this case, an operation such that, for example, when four addresses “a0, a1, a2, a3” are input in this order, a device a burst-transfers four data “d0, d1, d2, d3” corresponding to these addresses “a0, a1, a2, a3” to the external memory, by a converter that converts these addresses to “a0, a1, a3, a2”. In this case, the correspondence between the respective addresses and data from the device α at a transfer source to the converter becomes “a0-d0” (indicating that a0 and d0 correspond to each other), “a1-d1”, “a2-d2”, and “a3-d3”. Further, the correspondence from the converter to the external memory becomes “a0-d0”, “a1-d1”, “a3-d2”, “a2-d3”. Data d0 is written in address a0 of the external memory, data d1 is written in address a1, data d3 is written in address a2, and data d2 is written in address a3. In this state, when a device β that accesses the external memory without via the converter reads information from addresses a0 to a3, the correspondence between the read data and the address becomes “a0-d0”, “a1-d1”, “a3-d2”, and “a2-d3”, because the correspondence between the address and the data stored in the external memory is maintained. As a result, the correspondence between the address and the data in the device α and that in the device β do not match each other. That is, although the device α and the device β specify the same address to read the data, different pieces of data are read.

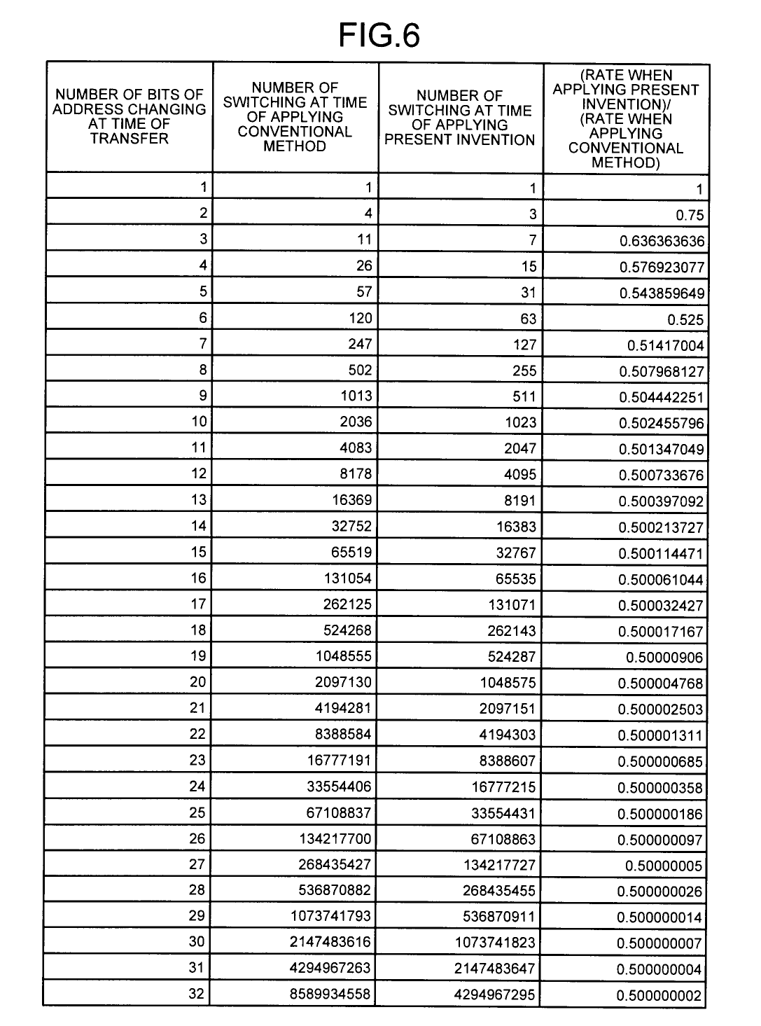

FIG. 6 is a table of comparison results between the total number of switching when the bit is changed according to a conventional method, in which the access destination address is generated while incrementing the top address, and the total number of switching when the method according to the first embodiment is applied to change the bit. FIG. 6 is a table of an example where the number of switching is reduced using the gray code counter. As shown in FIG. 6, the effect increases with an increase of the number of bits that change at the time of the burst access. When the gray code counter is used, as the number of bits that change increases, the number of switching becomes about half the number at the time of applying the sequential access method.

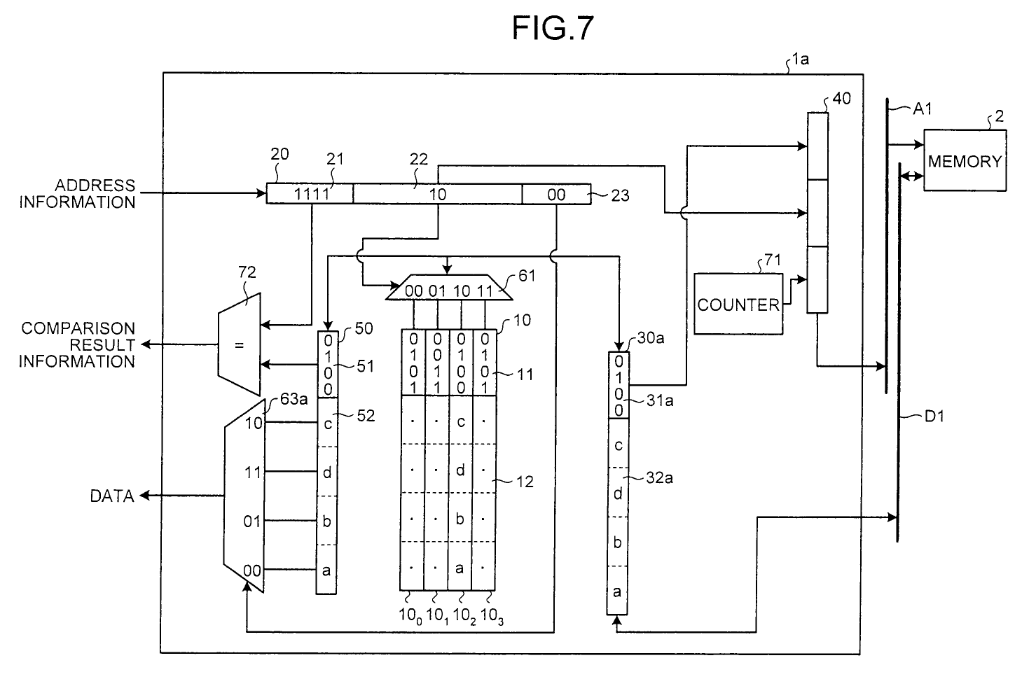

The configuration of the cache system is not limited to the configuration shown in FIG. 1. For example, a configuration shown in FIG. 7 can be used. In a cache system la shown in FIG. 7, as compared to the cache system shown in FIG. 1, a two-way shift register 30a is provided instead of the second register 30 and the second MUX/DEMUX 62, and an MUX 63a is provided instead of the MUX 63. The two-way shift register 30a includes a tag field 31a and a data field 32a, and is controlled so that a shift direction becomes opposite to each other between a case of writing data in the memory 2 and a case of reading the data from the memory 2.

In the cache system la, the data read by performing the burst access to the memory 2 is stored in the data field 32a of the two-way shift register 30a and then in the cache memory 10, in the read order. That is, the data is stored in the data field 32a in an order corresponding to an order of change of a value output to the address bus A1. On the other hand, the access destination address output to the address bus A1 is generated using the gray code output from the counter 71, as in the cache system 1. Therefore, the order of data stored in each cache line of the cache memory 10 becomes different from the original address order (an order of address with the value thereof being incremented). Accordingly, the MUX 63a selects the output from the data field 52 of the fourth register 50 so that data corresponding to the original address is output to the CPU core.

Further, an example in which the external devices 201 and 202 are general cache systems has been explained above. However, the external devices 201 and 202 are not limited to the cache system. For example, the data processing circuit according to the first embodiment can be also applied to a system which has a function of performing a general burst access (a burst access in which the access destination address is generated while incrementing the top address).

A second embodiment of the present invention is explained next. While an example in which the data processing circuit is applied to the cache system has been explained in the first embodiment, in the second embodiment, the data processing circuit is applied to a Direct Memory Access (DMA) controller.

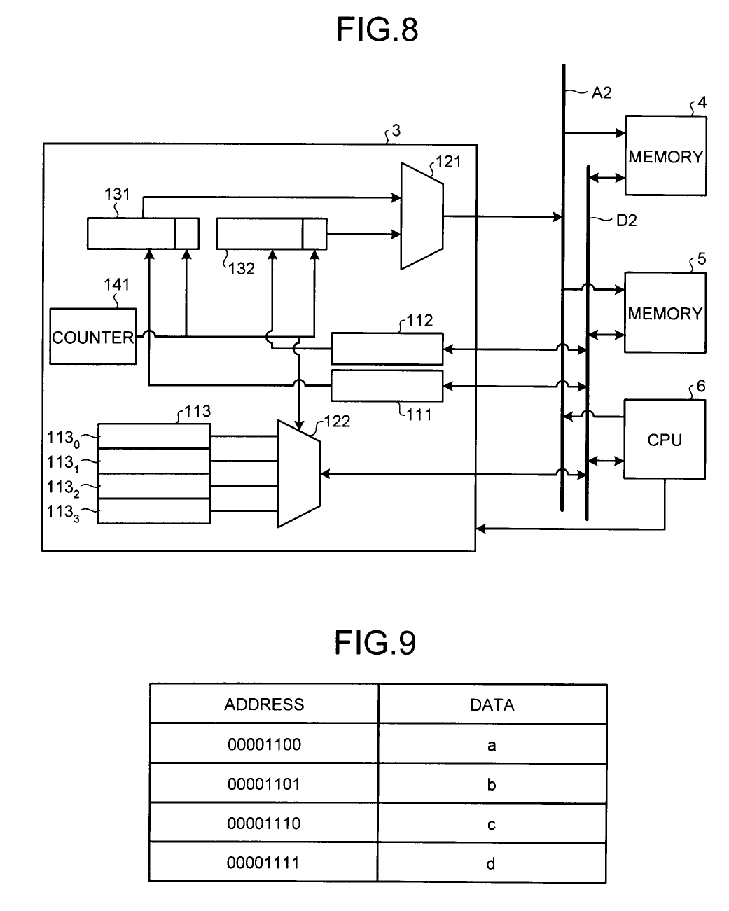

FIG. 8 is a configuration example of a data transfer apparatus including the data processing circuit according to the second embodiment and operating as the DMA controller. A data transfer apparatus 3 realizes DMA transfer between external memories 4 and 5 connected to each other via an address bus A2 and a data bus D2. Further, a burst access is performed at the time of data reading from respective memories and data writing to the memories in the DMA transfer.

The data transfer apparatus 3 includes an input-source address register 111, an input-destination address register 112, a data holding buffer 113, an MUX 121, a MUX/DEMUX 122, an output-source address register 131, an output-destination address register 132, and a counter 141. The data holding buffer 113 includes data storage areas 113₀ to 113₃.

The input-source address register 111 stores a source address indicating a storage position of data to be DMA transferred, which is received from a CPU 6.

The input-destination address register 112 stores a destination address indicating a transfer destination of the data to be DMA transferred, received from the CPU 6.

The data holding buffer 113 temporarily stores the data to be DMA transferred.

The MUX 121 has inputs of two-line signals and selectively outputs either one signal.

The MUX/DEMUX 122 selectively outputs data having the number of bits corresponding to a bus width of the data bus D2 from data rows stored in the data holding buffer 113.

The output-source address register 131 stores a source address to be output to the address bus A2.

The output-destination address register 132 stores a destination address to be output to the address bus A2.

The counter 141 generates the gray code at the time of the burst access by the data transfer apparatus 3 to the memory 4 or 5, and outputs the gray code to the output-source address register 131, the output-destination address register 132, and the MUX/DEMUX 122.

This is an example of a system in which a transfer size by the data transfer apparatus 3 per transfer is fixed to 4 bytes, and the address specified at the time of transfer must be 4 bytes aligned. It is assumed that an address bus width and a data bus width are both eight bits.

A DMA transfer operation performed by the data transfer apparatus 3 using the data processing circuit according to the second embodiment is explained with reference to the accompanying drawings. An operation when 4-byte data stored in the memory 4 is DMA transferred to the memory 5 is explained as one example. It is assumed that addresses 00000000 to 01111111 are mapped in the memory 4 and addresses 10000000 to 11111111 are mapped in the memory 5, and a source address of the processing data (data to be transferred) is 00001100, and a destination address thereof is 10001000. It is also assumed that pieces of data as shown in FIG. 9 are stored in 4 bytes starting from the address 00001100, and ‘a’, ‘b’, ‘c’, and ‘d’ are respectively 8-bit data.

The CPU 6 first outputs the source address (00001100) and the destination address (10001000) of the processing data to the data transfer apparatus 3 via the data bus D2. In the data transfer apparatus 3, the source address received from the CPU 6 is stored in the input-source address register 111 and the destination address is stored in the input-destination address register 112. The CPU 6 issues a start instruction of DMA transfer to the data transfer apparatus 3. When having received the DMA transfer start instruction from the CPU 6, the data transfer apparatus 3 reads values of higher-order six bits of the source address stored in the input-source address register 111 as information of the higher-order six bits of the output-source address register 131. Further, the data transfer apparatus 3 reads values of higher-order six bits of the destination address stored in the input-destination address register 112 as information of the higher-order six bits of the output-destination address register 132.

The data transfer apparatus 3 issues a burst read request to the memory 4 for the source address stored in the output-source address register 131. The MUX 121 selects source address information output from the output-source address register 131 and outputs the information to the address bus A2, and acquires data corresponding to the output source address information via the data bus D2. The acquired data is stored in the data holding buffer 113. The counter 141 counts up synchronously with the burst read timing to change a 2-bit output value according to a counter value. Accordingly, source address information to be output to the address bus A2 via the MUX 121 is sequentially changed, and 4-byte data stored in the areas of addresses 00001100 to 00001111 of the memory 4 is fetched into the data holding buffer 113 of the data transfer apparatus 3.

The counter 141 is the gray code counter the same as the counter 71 provided in the cache system 1 according to the first embodiment, and changes only one bit of the 2-bit output, so that the output value becomes the gray code.

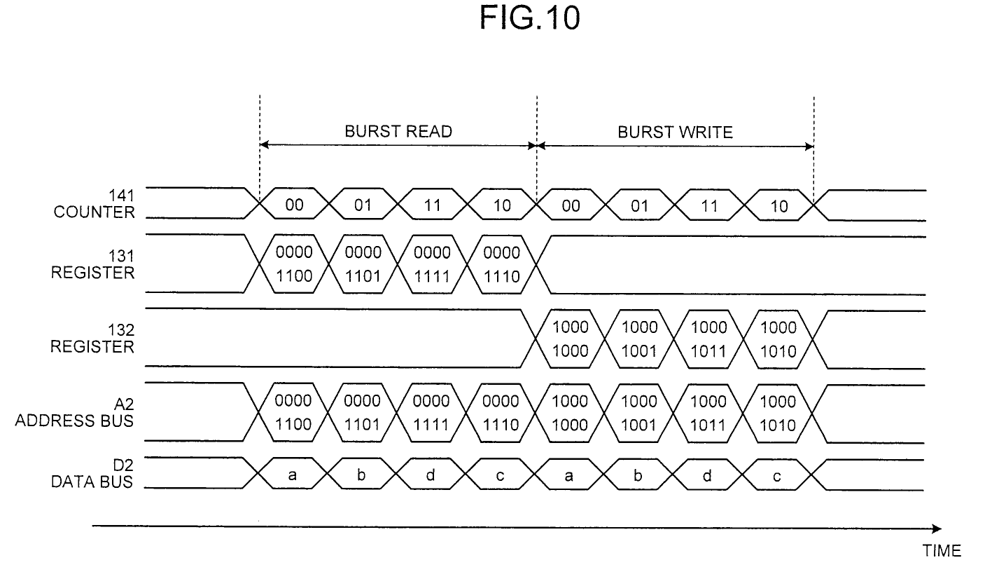

A burst-read operation performed by the data processing circuit according to the second embodiment is explained here in detail with reference to FIG. 10. At a point in time when the burst read is started, in the data transfer apparatus 3, the counter 141 outputs the initial value “00”. Therefore, the information stored in the output-source address register 131 becomes “00001100”, which is output to the address bus A2 as the access destination address. The memory 4 then outputs data stored in the area corresponding to the state of the address bus A2 (access destination address) to the data bus D2. Specifically, ‘a’ is output. On the other hand, in the data transfer apparatus 3, the output value of the counter 141 is also output to the MUX/DEMUX 122, and the MUX 121 stores the data output from the memory 4 to the data bus D2 in the area of the data holding buffer 113 corresponding to the output value of the counter 141 (to any one of the data storage areas 113₀ to 113₃). As a result, as shown in FIG. 10, data ‘a’ is read from the memory 4, and stored in the data holding buffer 113.

Thereafter, when a predetermined time has passed, the counter 141 counts up in the data transfer apparatus 3, and the output value of the counter 141 changes to “01”. Accompanying this procedure, the information stored in the output-source address register 131 becomes “00001101”, which is output to the address bus A2, and data ‘b’ is output from the memory 4. Data ‘b’ is then stored in the data storage area in the data holding buffer 113 corresponding to the output value of the counter 141.

Thereafter, in the data transfer apparatus 3, when the counter 141 further counts up, the output value thereof changes to “11”, because the counter 141 generates the gray code. Accompanying this procedure, “00001111” is output from the output-source address register 131 to the address bus A2, and the data transfer apparatus 3 stores data ‘d’ output from the memory 4 in the data storage area in the data holding buffer 113 corresponding to the output value of the counter 141.

Further, in the data transfer apparatus 3, when the counter 141 further counts up, the counter 141 outputs “10”1, and “00001110” is output from the output-source address register 131 to the address bus A2. The data transfer apparatus 3 stores data ‘c’ output from the memory 4 in the data storage area in the data holding buffer 113 corresponding to the output value of the counter 141.

The series of address data output to the address bus A2 is output in an order different from the original address order (alignment sequence output sequentially from a smaller value). Accompanying this procedure, the order of data output to the data bus D2 also changes like ‘a’→‘b’→‘d’→‘c’. Further, when the data output to the data bus D2 is stored in the data holding buffer 113, the data is stored in the area corresponding to the output value of the counter 141, referring to the output value of the counter 141 used for generating the address to be output to the address bus A2. Accordingly, the correspondence between the address and data is maintained before and after the burst read process.

When the burst read finishes for the 4-byte data, the data transfer apparatus 3 issues a burst write request to the memory 5 for the destination address stored in the output-destination address register 132. When the burst write is to be performed, the MUX 121 selects destination address information output from the output-destination address register 132 and outputs the information to the address bus A2. Further, the data transfer apparatus 3 sequentially outputs the data stored in the data holding buffer 113 (the 4-byte data acquired from the memory 4 by the burst read process) to the data bus D2. That is, the MUX/DEMUX 122 selects the output data from the data holding buffer 113 according to the output value from the counter 141, and outputs the output data to the data bus D2.

The counter 141 counts up synchronously with the burst write timing to change the 2-bit output value according to the counter value, as in the case of performing burst read. Accordingly, the destination address information to be output to the address bus A2 via the MUX 121 is sequentially changed, and 4-byte data is stored in the areas of addresses 10001000 to 10001011 of the memory 5. The correspondence of the output of the counter 141, the output of the MUX 121 (the output of the output-source address register 131 and the output of the output-destination address register 132), the address data on the address bus A2, and the data on the data bus D2 when the data transfer apparatus 3 stores the data in the memory 5 is as shown in the right half of the timing chart shown in FIG. 10.

A burst-write operation performed by the data processing circuit according to the second embodiment is explained in detail with reference to FIG. 10. At a point in time when the burst write is started, in the data transfer apparatus 3, the counter 141 outputs the initial value “00”. Therefore, the information stored in the output-destination address register 132 becomes “10001000”, which is output to the address bus A2 as the access destination address. At this time, the MUX/DEMUX 122 outputs the data stored in the area in the data holding buffer 113 corresponding to the output value of the counter 141 to the data bus D2. Specifically, data ‘a’ is output. On the other hand, the memory 5 acquires the information output to the data bus D2, and stores the information in the area corresponding to the state of the address bus A2 (the access destination address). That is, data ‘a’ is stored in the area of address “10001000” of the memory 5.

Thereafter, when a predetermined time has passed, the counter 141 counts up in the data transfer apparatus 3, and the output value of the counter 141 changes to “01”. Accompanying this procedure, the information stored in the output-destination address register 132 becomes “10001001”, which is output to the address bus A2. At this time, the MUX/DEMUX 122 outputs data ‘b’ stored in the area in the data holding buffer 113 corresponding to the output value of the counter 141 to the data bus D2. On the other hand, the memory 5 stores the information output to the data bus D2 in the area corresponding to the state of the address bus A2 (the access destination address). That is, data ‘b’ is stored in the area of address “10001001” of the memory 5.

Thereafter, in the data transfer apparatus 3, when the counter 141 further counts up, the output value thereof changes to “11”, because the counter 141 generates the gray code. Accompanying this procedure, “10001011” is output from the output-destination address register 132 to the address bus A2. At this time, the MUX/DEMUX 122 outputs data ‘d’ stored in the area in the data holding buffer 113 corresponding to the output value of the counter 141 to the data bus D2. On the other hand, the memory 5 stores the information output to the data bus D2 in the area corresponding to the state of the address bus A2 (the access destination address). That is, data ‘d’ is stored in the area of address “10001011” of the memory 5.

Further, in the data transfer apparatus 3, when the counter 141 further counts up, the counter 141 outputs “10”, and “10001010” is output from the output-destination address register 132 to the address bus A2. At this time, the MUX/DEMUX 122 outputs data ‘c’ stored in the area in the data holding buffer 113 corresponding to the output value of the counter 141 to the data bus D2. On the other hand, the memory 5 stores the information output to the data bus D2 in the area corresponding to the state of the address bus A2 (the access destination address). That is, data ‘c’ is stored in the area of address “10001010” of the memory 5.

The address data to be output to the address bus A2 is output in an order different from the original address order (alignment sequence output sequentially from a smaller value). Accompanying this procedure, the order of data output to the data bus D2 also changes like ‘a’→‘b’→‘d’→‘c’. Accordingly, the correspondence between the address and data is maintained before and after the burst write process.

By performing the above operation, DMA transfer from the memory 4 to the memory 5 is complete. In the DMA transfer operation by the conventional data transfer apparatus using the general 2-bit counter as the counter 141, the output to the address bus A2 changes in order of “00001100”→“00001101” (1-bit change)→“00001110” (2-bit change)→“00001111” (1-bit change)→“10001000” (4-bit change)→“10001001” (1-bit change)→“10001010” (2-bit change)→“10001011” (1-bit change), in which total change is 12 bits. On the other hand, in the DMA transfer operation by the data transfer apparatus 3 according to the second embodiment, the output to the address bus A2 changes in order of “00001100”→“00001101” (1-bit change)→“00001111” (1-bit change)→“00001110” (1-bit change)→“10001000” (3-bit change)→“10001001” (1-bit change)→“10001011” (1-bit change)→“10001010” (1-bit change), in which the total change is nine bits.

In the second embodiment, to simplify the explanations, an example in which the number of address bits that change at the time of the burst access is two has been explained. However, even when there is three or more bit change, the data transfer apparatus 3 controls the address data output so that the number of switching is reduced than in the conventional apparatus.

Thus, in the data transfer apparatus according to the second embodiment, when the data stored in the memory 4 is DMA-transferred to the memory 5, burst read of desired data is first performed from the memory 4 using the gray code generated by the counter 141, while changing the access destination address to be output to the address bus bit by bit. Burst write of the desired data acquired from the memory 4 to the memory 5 is then performed using the gray code generated by the counter 141, while changing the access destination address to be output to the address bus bit by bit. At this time, respective pieces of data read from the memory 4 are temporarily stored in the area in the data holding buffer 113 corresponding to the output value of the counter 141. Accordingly, the number of address bits changing at the time of performing a burst access in the DMA transfer (the number of switching) is reduced than in the conventional apparatus, and the correspondence between the respective pieces of data to be burst-accessed and the address corresponding thereto can be maintained before and after the burst access process. Accordingly, even when the data processing circuit according to the second embodiment is applied to a partial device in the system in which a plurality of devices accesses a common external memory, the power consumption in the address bus between the respective devices and the common external memory can be individually reduced, while maintaining the state where the correspondence between the address and the data matches among the respective devices.

Further, flexible use can be considered such that the data processing circuit is applied only to a device having high frequency of performing the burst access, among the respective devices that access the common external memory. When the data processing circuit is applied, switching noise can be also reduced as well as the power consumption.

In the explanations of the first and second embodiments, a case that the output of the counter is a 2-bit gray code has been described. However, when the counter having an output of three or more bits is used, even a counter that outputs a value other than the gray code can reduce the number of switching, as compared to a case that a general counter is used. For example, in a case that the output is three bits, if a general counter is used, the output value changes “100”→“001”→“010”→“011”→“100”→“101”→“110”→“111”, in which the total number of switching becomes 11. On the other hand, when it is assumed that the output value changes “000”→“001”→“011”→“111”→“110”→“100”→“101”→“010”, the total number of switching becomes 9, and therefore the number of switching can be reduced. The total number of switching at the time of outputting the gray code is 7. Therefore, the second embodiment is not limited to a case of using the counter for outputting the gray code, and any counter can be used as long as the counter can change the output value in an order of decreasing the number of switching than general counters.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data processing circuit that performs a burst access to an external memory, comprising:
an address generating unit that generates a series of access destination addresses at a time of performing a burst access to the external memory, starting from an initial address to be accessed, so that number of inverted bits along with the address change becomes smallest;
a data holding unit that holds data to be written in the external memory or data read from the external memory; and
a data processing unit that reads the data held in the data holding unit and writes the data in the external memory in order of the access destination addresses, or reads the data from the external memory in order of the access destination addresses and writes the data in the data holding unit.

2. The data processing circuit according to claim 1, wherein the address generating unit changes one bit to generate the access destination address.

3. The data processing circuit according to claim 1, wherein the address generating unit generates the access destination address by converting a lower-order bit of the initial address to a gray code.

4. A cache system comprising:
the data processing circuit according to claim 1 and a cache memory, wherein
data reading and data writing with respect to the cache memory are performed by using a burst access by the data processing circuit.

5. The cache system according to claim 4, wherein the address generating unit changes one bit to generate the access destination address.

6. The cache system according to claim 4, wherein the address generating unit generates the access destination address by converting a lower-order bit of the initial address to a gray code.

7. A data transfer apparatus comprising:
the data processing circuit according to claim 1; and
a data buffer that temporarily stores the data acquired from outside, wherein
DMA transfer between two external memories is performed by using a burst access by the data processing circuit.

8. The data transfer apparatus according to claim 7, wherein the address generating unit changes one bit to generate an access destination address.

9. The data transfer apparatus according to claim 7, wherein the address generating unit generates the access destination address by converting a lower-order bit of the initial address to a gray code.
